(19) United States
(12) Patent Application Publication
(10) Pub. No.: US 2015/0201050 A1
(43) Pub. Date: Jul. 16, 2015

(54) MOBILE PHONE PROTECTIVE SHELL WITH HIDDEN MAGNETS

(71) Applicant: SAMYA TECHNOLOGY CO., LTD., Taoyuan County (TW)

(72) Inventor: FU-I YANG, TAOYUAN COUNTY (TW)

(73) Assignee: SAMYA TECHNOLOGY CO., LTD., Taoyuan County (TW)

(21) Appl. No.: 14/153,189

(22) Filed: Jan. 13, 2014

(51) Int. Cl. H04M 1/02; H04B 1/38

(52) U.S. Cl. CPC H04M 1/0202; H04B 1/3833; H04B 1/3888

(57) ABSTRACT

A mobile phone protective shell with hidden magnets comprises a casing having a platform and an engaging portion at a periphery of the platform positioned around the mobile phone to form a back protective device for engaging with the mobile phone; wherein the platform has an inner side and an outer side to form a full outline of a protective shell, and two magnets in a thickness less than 1.8 mm and a diameter of 25-30 mm are arranged between the inner side and outer side to be in an upper and lower symmetry hidden in the platform, and the magnets are powerful Nd—Fe—B magnets having magnetic field strength more than 6000 gauss; whereby when the casing is subjected to the weight of the mobile phone, the casing can be attracted and fixed upright to the object with permeability.

### BACKGROUND OF THE INVENTION

1. Field of the Invention

The invention relates to a mobile phone protective shell with hidden magnets, particularly to the hidden magnets having certain magnetic force for carrying the weight of mobile phone, and being attracted and fixed on the permeability objects.

2. Description of the Related Art

With the rapid evolution of technology, the mobile phones have almost become indispensable paraphernalia in people's lives, especially to the high-value smartphones; so many users will install protective shell or protective sleeve in order to prevent collision damage.

The front side (LCD panel) of the smartphone is a user's operation interface, so most of the protective shells are provided for protecting the back of the smartphone to prevent wear and tear while contacting with the desktop. Some protective shells have anti-slip function to prevent slippage and shaking of the phone on the desktop, affecting the operation and stability; thus, phone protective shell does have usefulness.

The current mobile phone protective shell, which is provided with a magnet, is only for fixing to the cover, so the attraction force is not enough for attracting and fixing on the office screen or computer housing. In the prior art, the protective shell can be attracted to the office screen or computer casing, but the magnet is exposed at the outside of the protective shell, not only destroying the aesthetics but integrity of the protective shell. Moreover, the magnetic field formed by the magnet can prevent phone rattling during operation while placing the protective shell on permeability desktop. However, it is doubt that if the magnetic field can make the mobile phone and protective shell upright attracted by the permeability object without falling.

Therefore, the present invention is designed to overcome the problems of traditional phone protective shell of points.

### SUMMARY OF THE INVENTION

It is an object of the present invention to provide a mobile phone protective shell with hidden magnets for being attracted and fixed on the objects with permeability to enhance the applicable field and using efficiency of the protective shell.

It is another object of the present invention to provide a mobile phone protective shell with hidden magnets having the hidden magnets which will not destroy the aesthetic and original decorative features of the protective shell.

In order to achieve the above objects, the mobile phone protective shell with hidden magnets comprises a casing depending on a predetermined dimensions of a mobile phone back having a platform and an engaging portion at a periphery of the platform positioned around the mobile phone to form a back protective device for engaging with the mobile phone; wherein the platform has an inner side and an outer side to form a full outline of a protective shell, and two magnets in a thickness less than 1.8 mm and a diameter of 25-30 mm are arranged between the inner side and outer side to be in an upper and lower symmetry hidden in the platform, and the magnets are powerful Nd—Fe—B magnets having magnetic field strength more than 6000 gauss.

Whereby when the casing is subjected to the weight of the mobile phone, the casing can be attracted and fixed upright to the object with permeability.

Based on the features disclosed, the present invention allows mobile phones to be attracted and fixed on the permeability objects, such as housing of computer hosts, office screens, tables, chairs, refrigerator shell, and other objects with permeability surrounding the user to enhance the applicable field of the protective shell. Moreover, the hidden magnets will not destroy the aesthetic and original decorative features of the protective shell.

### BRIEF DESCRIPTION OF THE DRAWINGS

FIG. 1 is an exploded schematic view of the preferred embodiment in accordance with the present invention;

FIG. 2 is an assembly schematic view of the preferred embodiment in accordance with the present invention;

FIG. 3A is an assembly schematic view of the preferred embodiment, showing another angle of the present invention;

FIG. 3B is an appearance perspective view of the preferred embodiment in accordance with the present invention, showing the magnets being not viewed from the appearance;

FIG. 4 is a sectional view of the preferred embodiment in accordance with the present invention; and

FIG. 5 is an application example of the present invention.

### DETAILED DESCRIPTION OF THE PREFERRED EMBODIMENT

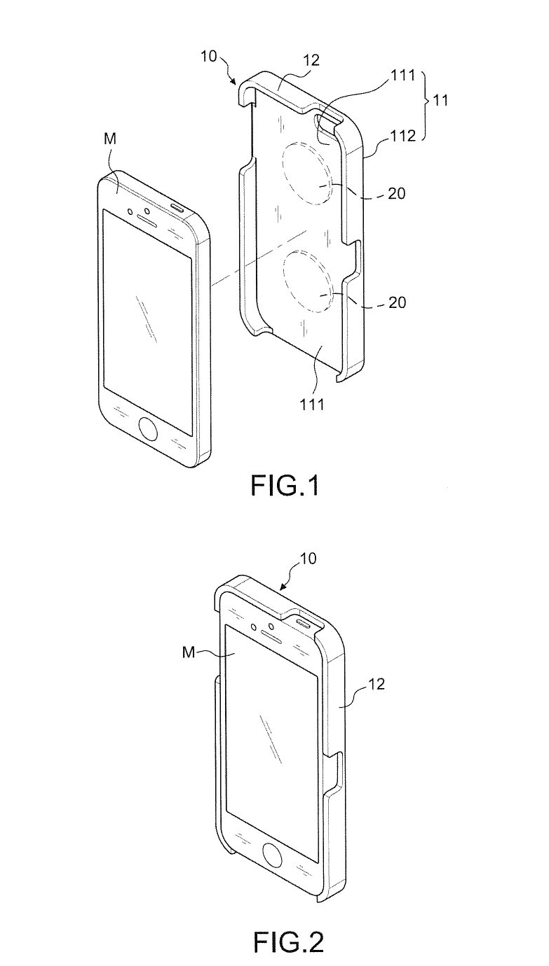

Referring to FIGS. 1 through 3A, the preferred embodiment of a mobile phone protective shell with hidden magnets in accordance with the present invention comprises a casing 10 depending on a predetermined dimensions of a mobile phone M back having a platform 11 and an engaging portion 12 at a periphery of the platform 11 positioned around the mobile phone M to form a back protective device for engaging with the mobile phone M. However, it is prior art and thus will not be described in detail here.

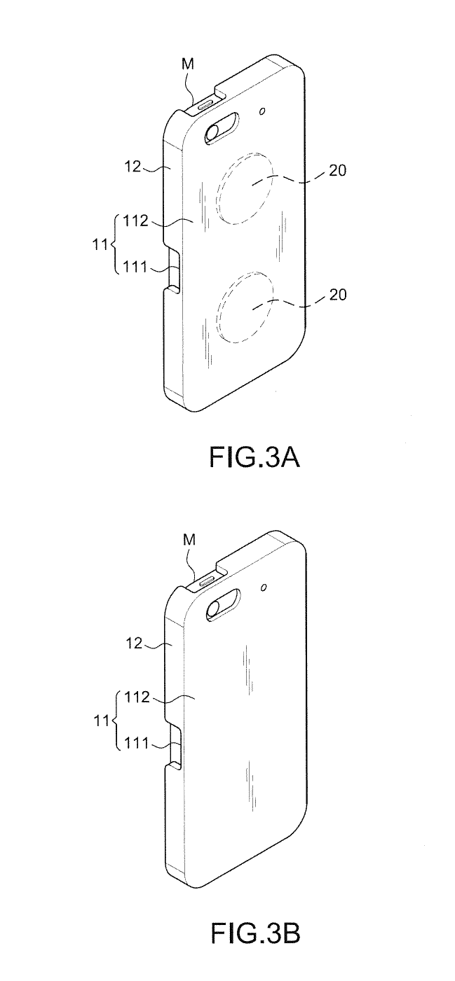

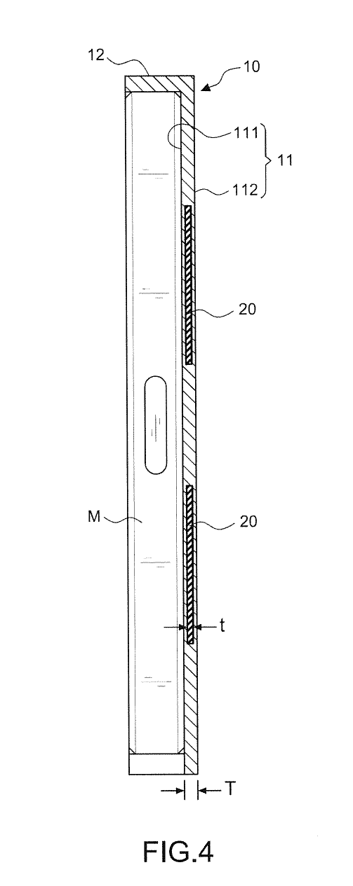

With the reference to FIGS. 3B and 4, the present invention is characterized in that the platform 11 has an inner side 111 and an outer side 112 to form a full outline of a protective shell, and two magnets 20 in a thickness less than 1.8 mm and a diameter of 25-30 mm are arranged between the inner side 111 and outer side 112 to be in an upper and lower symmetry hidden in the platform 11. That is, the magnets 20 cannot be seen from the surface of the casing 10. The magnets 20 can be set up in the mold with for injection molding with the casing 10, or be hidden by machining processes such as the use of high frequency. Besides, the present invention has a predetermined magnetic attraction force. When the casing 10 is subjected to the weight of the mobile phone M, the casing 10 can be attracted and fixed upright to the object 30 with permeability. Accordingly, the thickness t of the magnet is less than 1.8 mm, in order to comply with the general protective shell of thickness T less than 2.5 mm. If the thickness t of the magnet exceeds 1.8 mm, the magnet cannot be overmolded so that the magnets are exposed to the surface of the casing 10, damaging the aesthetics of the protective shell. In addition, if the increasing the protective shell thickness T, the overall thickness more than 2.5 mm will become unwieldy, losing practicality.

In the embodiment, the magnets 20 are two circular magnets in an upper and lower symmetry has diameter about 25 to 30 mm for having a predetermined attraction area but it is not a limitation. The magnet may be in rectangular or other geometric shapes, and may include one or more of the magnets. After the actual tests, iphone5s phone, for example, weighs 112 grams. When the casing 10 carries the mobile phone M, the magnetic field strength is required to 6000 gauss or more in order to be attracted and fixed on the permeability object 30, or it is easy to damage the mobile phone M by loosening the casing 10.

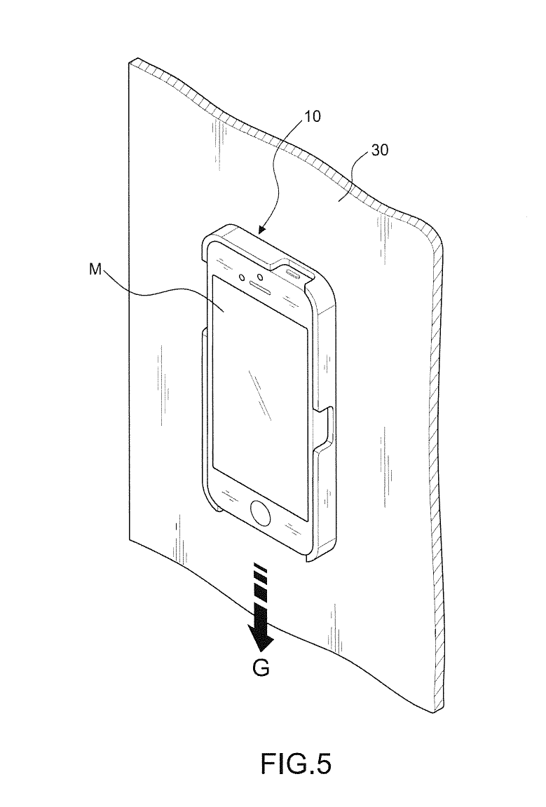

Therefore, the magnets 20 in the embodiment are Nd—Fe—B magnets. The two circular magnets with diameter about 25-30 mm and thickness of 1.4 mm −1.8 mm has magnetic field strength of 7200-7500 gauss after the two circular magnets are arranged in upper and lower symmetry. As a result of the practical test, when the casing 10 carries the commercial smart phones such as iphone5s, the magnetic field strength is greater than the gravity G of mobile phone M. With the reference to FIG. 5, the present invention enables the mobile phones to be attracted and fixed on the objects with permeability, such as housing of computer hosts, office screens, tables, chairs, refrigerator shell, and other permeability objects surrounding the user.

With the reference to FIGS. 1 to 3A, the casing 10 with built-in magnets 20 is independent molding with the protective shell of mobile phone M but it is not a limitation, the casing 10 with built-in magnets 20 can be combined to the back cover of the mobile phone M (not shown); that is, the magnets 20 is directly hidden in the back cover of the mobile phone M.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A mobile phone protective shell with hidden magnets, comprising:
a casing depending on a predetermined dimensions of a mobile phone back, and having a platform and an engaging portion at a periphery of the platform positioned around the mobile phone to form a back protective device for engaging with the mobile phone;
wherein the platform has an inner side and an outer side to form a full outline of a protective shell, and two magnets in a thickness less than 1.8 mm and a diameter of 25-30 mm are arranged between the inner side and outer side to be in an upper and lower symmetry hidden in the platform, and the magnets are powerful Nd—Fe—B magnets having magnetic field strength more than 6000 gauss;
whereby when the casing is subjected to the weight of the mobile phone, the casing can be attracted and fixed upright to the object with permeability.

2. The foldable house as claimed in claim 1, wherein the casing with built-in magnets is a protective shell independent molding on mobile phones.
